(19) United States
(12) Patent Application Publication
(10) Pub. No.: US 2014/0095584 A1
(43) Pub. Date: Apr. 3, 2014

(54) SYSTEM AND METHOD FOR DIRECTING USERS TO WEB CONTENT

(71) Applicants: Michael Archuleta, Austin, TX (US); Michael Archuleta, II, Austin, TX (US); Austin Archuleta, Austin, TX (US)

(72) Inventors: Michael Archuleta, Austin, TX (US); Michael Archuleta, II, Austin, TX (US); Austin Archuleta, Austin, TX (US)

(21) Appl. No.: 13/633,621

(22) Filed: Oct. 2, 2012

(51) Int. Cl. H04L 29/08

(52) U.S. Cl. CPC H04L 67/02
USPC 709/203

(57) ABSTRACT

A system and method is provided that enables a business to purchase a generic, but unique, kit containing one or more signs, with a machine readable medium. The computer readable medium stores information relating to a unique web address of a configurable web site landing page. An administrator configures the web site as desired so that when a user scans the machine readable medium, the user will be direct to the web site, and will have access to the content configured by the administrator.

### FIELD

This disclosure relates to social media. In particular, this disclosure is drawn to a system for directing users to web content of merchants and service providers.

### BACKGROUND

It is common for businesses, groups, organizations, clubs, etc., to use social media as a form of promotion, and to communicate with people. Social networking allows businesses to reach out to potential customers without a huge advertising budget, while also staying in touch with current customers.

One challenge for a business using social networks as a promotional tool relates to the difficulty of getting current and potential customers to use social networks to communicate with the business. Typically, a business will provide customers with their social network handle or a URL, and hope the customers take the initiative to use that information to communicate with the business. This process typically results in a low acquisition rate.

### SUMMARY

A method is provided for linking users to online content using a mobile device, the method including providing a plurality of kits, each kit further comprising one or more signs, each sign having a machine readable medium storing a web address that is unique from web addresses in other kits, providing a web server for serving a plurality of web sites, selecting a kit from the plurality of kits, configuring the web server to host a web site at the unique web address, and configuring the content of the web site such that desired content is provided to a user who reads the machine readable medium of a respective sign.

Another embodiment provides a system for linking users to online content using a mobile device, the system including one or more signs, a machine readable medium formed on each respective sign, the machine readable medium storing information relating to an online address, and a web server configured to host a web page at the online address, wherein when a user reads the machine readable medium using a mobile device, a browser on the mobile device is directed to the web page.

Another embodiment provides a method for linking customers to the online content of a business, the method including creating a plurality of generic kits, each generic kit being configured to include unique information, but not to include information specific to any particular business user so that a business user can use any of the plurality of generic kits, for each of the plurality of kits, one or more signs, each sign having a machine readable medium storing information relating to a web address that is unique from web addresses in other kits, providing a web server for serving a plurality of web sites, providing a kit from the plurality of generic kits to a business user, configuring the web server to host a web site at the unique web address of the kit provided to the business user, allowing the business user to configure the content of the web site, and serving the web site to a mobile device when a customer uses the mobile device to read the machine readable medium of a sign from the provided kit.

Other features and advantages of the present disclosure will be apparent from the accompanying drawings and from the detailed description that follows below.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of an examples of a system implemented in an internet environment.

FIGS. 2A-2D are diagrams of exemplary screen shots from a web browser, as it would be viewed by a user of a network client.

FIG. 3 is a diagram illustrating one example of a sign, including machine readable medium.

FIG. 4 illustrates one example of the contents of a kit.

FIG. 5 is a flowchart illustrating a process for registering a kit and configuring a web site landing page.

FIG. 6 is a flowchart illustrating a process for reading/scanning a sign and retrieving a web site landing page.

### DETAILED DESCRIPTION

Generally, the present disclosure relates to techniques for linking users to one or more social networks or web sites. In one example, in the context of a business trying to attract current and potential customers to one or more social networks and/or other web sites, the business is provided with unique signs, stickers, decals, cards, etc. Each sign includes one or more machine readable medium that can be read by a mobile device. The machine readable medium stores information, including information relating to a web address that can be accessed by a mobile device. In one example, a mobile device that reads the machine readable medium is directed to a web site landing page configured by an administrator to provide the user of the device with information and links relating to the business. Examples include, but are not limited to, information relating to the business, social networking services, pictures, videos, etc. Once the web site is configured as desired, a business can display the signs, stickers, decals, etc., where current and potential customers can use a mobile device (e.g., a smart phone) to scan the medium and quickly and effortlessly be directed to the online content of the web site. Detailed examples of this and related techniques are described below.

As described above, techniques are disclosed for easily directing users to web content configured by an administrator. In one example, a system is provided that enables a business (or other user) to purchase a generic, but unique, kit containing one or more signs, each with at least one machine readable medium. A generic kit is intended to mean a kit that, while having a unique identifier, is not customized for any particular pre-existing user such that any user can use any kit. In the exemplary implementation described above, the computer readable medium of each kit stores information relating to a unique web address of a configurable web site. An administrator is allowed to configure the web site as desired so that when a user scans the medium, the user will be direct to the web site, and will have access to the content configured by the administrator. This technique eliminates the need for customized signs that have to be configured for a preexisting web address or user account. As a result, a plurality of generic kits can be manufactured inexpensively and can be used by businesses to direct users to a specifically configured web site.

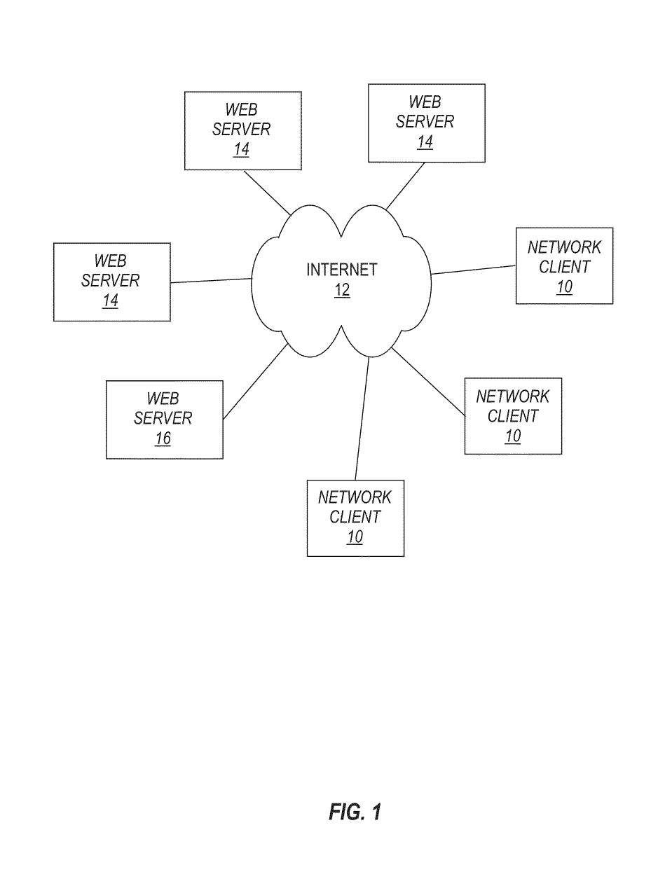

In order to provide a context for understanding this description, the following description illustrates an example of an environment in which the techniques described may be used. FIG. 1 is a block diagram of an example of the present disclosure implemented in a web environment. Note however, that the techniques can also be implemented in other environments. FIG. 1 is a block diagram showing a plurality of network clients 10 coupled to a network (in this example, internet 12). The network clients 10 may be any desired type of client, such as a smart phone, computer, tablet, PDA, network appliance, etc. A typical network client 10 may include a processor(s), a storage device(s) (memory, hard drive, etc.), user interface device (e.g., touch screen, keyboard, keypad, mouse, etc.) and a display.

A plurality of web servers 14 and 16 are also coupled to the internet 12. The web servers 14 and 16 host various web sites, which may be accessed and viewed by internet browsers installed on the network clients 10. When a user of one of the network clients 10 requests a web page hosted by the web servers 14 and/or 16, the web browser of the network client 10 will send a request to the respective web server, and will then retrieve web page content, which is displayed for a user of the network client 10.

As described above, in one example, a kit is provided that includes one or more signs, each with at least one machine readable medium. The machine readable medium stores information relating to a unique web site landing page address hosted by the web server 16 (FIG. 1). The user (e.g., a business owner) of a kit registers the kit by creating and logging into an account. The user is then allowed to configure the layout and content of the web site hosted at the unique web site address in any desired manner to provide desired information and links to current and potential customers that scan the signs.

Examples of web content include, but are not limited to, social networking services, links to web sites, pictures, videos, maps, reviews, surveys, contact information, business hours, wifi information, links to downloadable files, ecommerce tools, application shortcuts, etc. If desired, the web page can be formatted for optimal viewing on a mobile device, PC, tablet, etc. In one example, the web server detects the type of device requesting the web page, and provides the web content in an optimal format.

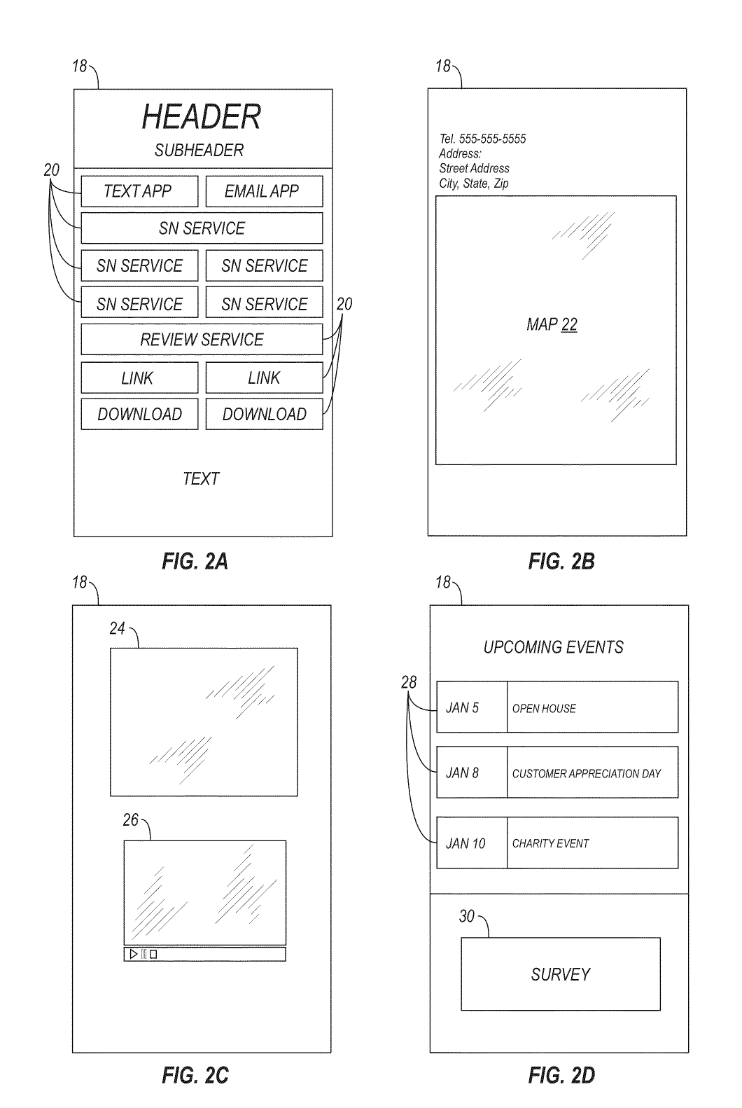

FIGS. 2A-2D are diagrams of exemplary screen shots from a web browser, as it would be viewed by a user of a network client 10. For clarity, menus, buttons, address lines, etc., are not shown in the examples. Note that the following examples are merely a few possible examples of web content, and that many other examples are possible. FIG. 2A is an exemplary screenshot 18 of the web page, including a header and sub-header, as defined by the user that configured the web page. FIG. 2A also shows a plurality of buttons 20 that are configured to provide links to web sites, links to the user's social networking services, links to the user's regular web site, text/email (or other) application shortcuts, file download links, etc. FIG. 2B is an exemplary screenshot 18 of the web page, including information relating to the location of a business, including an interactive map, a physical and/or mailing address, a telephone number, and any other desired contact information. FIG. 2C is an exemplary screenshot 18 of the web page, including one or more pictures 24 and videos 26. If desired, the web site can be configured to allow other users to upload pictures or videos. FIG. 2D is an exemplary screenshot 18 of the web page, including a calendar or listing of upcoming events 28 and a customer survey 30. The examples shown in FIGS. 2A-2D are merely a few examples of content that can be configured to be displayed on the web page. Any other desired layout and content can be displayed.

In the exemplary system described above, a generic, but unique, kit contains one or more signs, which can be used to direct customers to web content. Note that the term “sign” is intended to mean any item capable of being used to display information and/or provide access to a machine readable medium. The signs described can be displayed in any manner desired, such as being attached to a wall, window, or other surface, held upright by a base member, or incorporated with other items such as menus, brochures, etc. Other examples are also possible. In some examples, signs may be made from paper, cardboard, plastic, metal, stickers, decals, window clings, etc.

In one example, each sign includes at least one machine readable medium. As described above, each machine readable medium stores information that can be used to direct a user to web content upon reading or scanning the machine readable medium. For example, a user with a smart phone, tablet, or other portable device can use the device to read the machine readable medium and quickly and easily be directed to a web site landing page, as configured by the administrator. Examples of machine readable medium include optical bar codes (e.g., QR codes), near field communication (NFC) devices, magnetic stripes, smart chips, RFID tags, magnetic ink characters, Bluetooth (or similar wireless devices), etc.

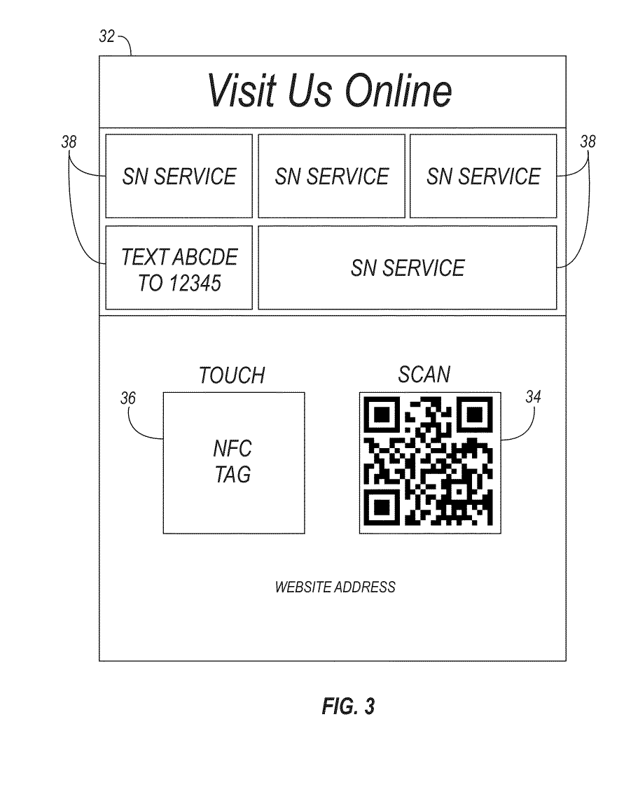

FIG. 3 is a diagram illustrating one example of a sign 32. In this example, the sign 32 includes machine readable medium 34 and 36. The medium 34 is an optical bar code (in this example, a QR code), which can be read by devices having an optical scanner and corresponding software (e.g., using the camera hardware on a smart phone). The medium 36, in this example, is an NFC tag imbedded in or adhered to the sign 32. The NFC tag can be read by a device having the appropriate NFC hardware and software.

When a user scans either medium, the user's device will be directed to a web page, such as the web pages shown in FIGS. 2A-2D. The sign 32 may also include instructions (e.g., “scan” in the case of the bar code or “touch” in the case of an NFC device) directing the user to use a device to read the medium. The example of FIG. 3 also includes one or more labels 38 that tell users what information or services are provided or linked on the web page landing page. In one example, the labels 38 are selected from a plurality of pre-printed repositionable labels, allowing the administrator to select and display desired labels. In the example of FIG. 3, the sign 32 uses five labels identifying four different social networking services that are linked on the landing page and one label that relates to a text message campaign (described below). The exemplary sign 32 of FIG. 3 also includes the URL of the web page landing page, allowing a user to access the web page if the user's device is unable to read the machine readable medium. Of course, any other desired information may also be provided on the sign.

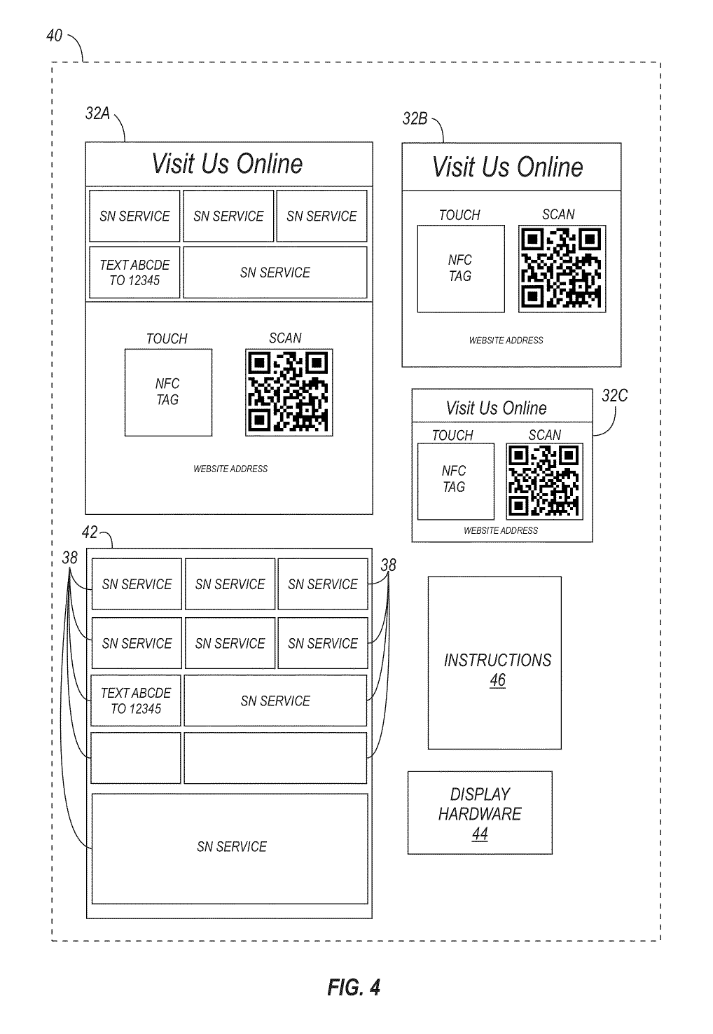

FIG. 4 illustrates one example of the contents of a kit described above. The kit 40 shown in FIG. 4 includes a plurality of signs, each having at least one machine readable medium. FIG. 4 shows a first sign 32A, similar to the sign shown in FIG. 3. In this example a plurality of signs (signs 32A, 32B, 32C) are provided in a variety of sizes and configurations.

The signs may also include a variety of types (e.g., paper, plastic, stickers, window clings, etc.), allowing the user to display multiple signs where desired. FIG. 4 also shows one or more sheets 42 of pre-printed and blank customizable labels 38 (like the repositionable labels 38 shown in FIG. 3) that can be adhered to the sign(s) to tell customers what social networking services and web sites are accessible on the web site landing page. A user may select any desired preprinted labels to place on the sign(s), as well as creating customized labels from the blank labels. FIG. 4 also shows display hardware 44 that may be used when displaying the signs 32. The display hardware 44 may include any desired type of hanging hardware (adhesives, hooks, anchors, suction cups, pins, etc.) for hanging signs. The display hardware 44 may also include a base member that can be used with a sign 32 to create a free standing sign that may be placed on a table, counter, shelf, or other horizontal surface. Therefore, the user has the option of displaying signs on walls, windows, countertops, tables, etc. The kit may also include instructions 46. The instructions 46 includes information relating to kit registration, website content and layout configuration, sign configuration, and scanning instructions.

Following is a description of the operation of the techniques described above, from a user purchasing a kit, to a customer scanning a sign and accessing a web site landing page. As mentioned above, a user (e.g., a business owner or other entity) is provided with a generic, but unique, kit. The user can use any generic kit, since the user is not limited to using a kit that has been customized for the user's pre-existing web sites or accounts. By eliminating the need for a kit that is customized for a particular user, the kits can be mass produced as a low cost, and used by any user.

Once a user obtains a kit, the user accesses a web site and begins a registration process. The user can then configure a web site landing page (such as that described above and shown in FIGS. 2A-2D) that is associated with the respective kit. Thereafter, when a customer scans the machine readable medium on a sign from the kit, the customer will be directed to the landing page, which has been configured by the user. In addition to configuring the web site, the user can also customize the signs, as described above. For example, if the user wishes to emphasize certain social network services or web sites, the corresponding labels 38 can be applied to the sign 32.

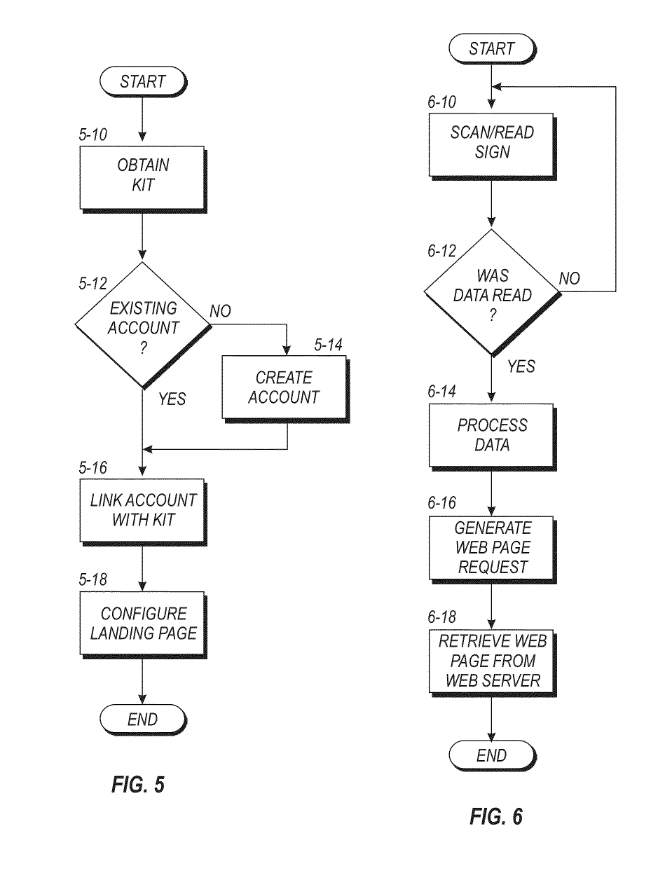

FIG. 5 is a flowchart illustrating an exemplary process for registering a kit and configuring a web site landing page. At step 5-10, a user obtains a kit, such as the kit shown in FIG. 4. If the user does not already have an account with the kit provider (step 5-12), an account is created at step 5-14. If the user already has an account, for example, if the user has previously registered another kit, the process proceeds to step 5-16. During the registration process, the user will be prompted to enter identification information provided with the kit, identifying which kit the user has purchased. At step 5-16, the user's account is linked with the particular kit purchased, so the machine readable medium in the signs will direct users to the appropriate landing page. At step 5-18, the user (i.e., administrator) configures the landing page. The user can configure the landing page layout and content (examples are shown in FIGS. 2A-2D). Thereafter, when a customer scans the machine readable medium, the customer will be directed to the landing page, and will view the content and layout defined by the administrator.

FIG. 6 is a flowchart illustrating an exemplary process of a customer (or other user) reading/scanning a sign and retrieving the web site landing page. At step 6-10, the customer uses a device (e.g., a smart phone) to read/scan the machine readable medium on a sign. In the example of an optical bar code, the user may use the device's camera hardware to scan the bar code. In the example of an NFC tag, the user places the device in the proximity of the NFC tag, and the NFC hardware in the device will read the NFC tag. If, at step 6-12, data was successfully read, the process proceeds to step 6-14, where the data is processed. If data was not successfully read, the process returns to step 6-10, and the user can attempt to read the medium again. The received data will include information relating to the address of the corresponding landing page.

A web browser in the device then generates a web page request for the respective web server (step 6-16), corresponding to the web site landing page. At step 6-18, the device retrieves the web site landing page from the web server (e.g., web server 16 of FIG. 1). At this point, the customer has access to any web content and links made available on the landing page. One benefit of the process described above is that a customer can be directed to various social media services with little effort, resulting in a higher acquisition rate versus when customers have to manually browse to each social media service.

As mentioned above with respect to the labels 38 of FIGS. 3 and 4, a label 38 may include information relating to a text messaging campaign. This information could also be printed on the sign itself, or be provided independent of the sign. Generally, a business can conduct a text messaging campaign by providing a short code text number, and a keyword that is unique to each kit. In the example shown in FIG. 3, the short text number is “12345” and the keyword for that particular kit is “ABCDE”. Multiple kits can share the same short text number, as long as the keywords are unique. In one example, for simplicity, the keyword can match the ending of the kit's unique URL. For example, if the unique URL of a particular kit is “www.[domainname].com/ABCDE”, then the text short code for that kit could be “ABCDE”.

Following is one example of how a kit user can use this feature. Like the examples above, the sign or label could include “Text ABCDE to 12345”, or something similar. When a customer texts “ABCDE” to 12345, an auto responder will reply with a message, as defined by the kit administrator, and a link to the web site landing page. The customer can then use the received link to access the web site landing page.

In the preceding detailed description, the disclosure is described with reference to specific exemplary embodiments thereof. Various modifications and changes may be made thereto without departing from the broader spirit and scope of the disclosure as set forth in the claims. The specification and drawings are, accordingly, to be regarded in an illustrative rather than a restrictive sense.

What is claimed is:

1. A method for linking users to online content using a mobile device, the method comprising:
providing a plurality of kits, each kit further comprising one or more signs, each sign having a machine readable medium storing a web address that is unique from web addresses in other kits;
providing a web server for serving a plurality of web sites;
selecting a kit from the plurality of kits;
configuring the web server to host a web site at the unique web address; and
configuring the content of the web site such that desired content is provided to a user who reads the machine readable medium of a respective sign.

2. The method of claim 1, wherein the machine readable medium includes an optical bar code.

3. The method of claim 1, wherein the machine readable medium includes a near field communication (NFC) tag.

4. The method of claim 1, wherein the machine readable medium includes an optical bar code and an NFC tag.

5. The method of claim 1, wherein the machine readable medium includes a Bluetooth device.

6. The method of claim 1, further comprising providing a plurality of pre-printed labels configured to fit on the plurality of signs, the plurality of pre-printed labels including information relating to the content of the web page.

7. The method of claim 1, wherein each kit includes a common short code text number and a unique keyword.

8. The method of claim 7, wherein the unique keyword for a respective kit relates to the web address stored in the respective machine readable medium.

9. A system for linking users to online content using a mobile device, the system comprising:
one or more signs;
a machine readable medium formed on each respective sign, the machine readable medium storing information relating to an online address; and
a web server configured to host a web page at the online address, wherein when a user reads the machine readable medium using a mobile device, a browser on the mobile device is directed to the web page.

10. The system of claim 9, wherein the machine readable medium includes an optical bar code.

11. The system of claim 9, wherein the machine readable medium includes an NFC tag.

12. The system of claim 9, wherein the machine readable medium includes an optical bar code and an NFC tag.

13. The system of claim 9, wherein the machine readable medium includes a Bluetooth device.

14. The system of claim 9, further comprising a plurality of pre-printed labels configured to fit on the one or more signs, the plurality of pre-printed labels including information relating to content on the web page.

15. The system of claim 9, further comprising a short code text number and a unique keyword.

16. A method for linking customers to the online content of a business, the method comprising:
creating a plurality of generic kits, each generic kit being configured to include unique information, but not to include information specific to any particular business user so that a business user can use any of the plurality of generic kits;
for each of the plurality of kits, one or more signs, each sign having a machine readable medium storing information relating to a web address that is unique from web addresses in other kits;
providing a web server for serving a plurality of web sites;
providing a kit from the plurality of generic kits to a business user;
configuring the web server to host a web site at the unique web address of the kit provided to the business user;
allowing the business user to configure the content of the web site; and
serving the web site to a mobile device when a customer uses the mobile device to read the machine readable medium of a sign from the provided kit.

17. The method of claim 16, wherein the machine readable medium includes an optical bar code.

18. The method of claim 16, wherein the machine readable medium includes an NFC tag.

19. The method of claim 16, further comprising, for each kit, providing a plurality of pre-printed labels configured to fit on the one or more signs, the plurality of pre-printed labels including information relating to the content of the web page.

20. The method of claim 16, wherein each kit further comprises a common short code text number and a unique keyword.
